(19) United States
(12) Patent Application Publication
(10) Pub. No.: US 2019/0098627 A1
(43) Pub. Date: Mar. 28, 2019

(54) MOBILE COMMUNICATION EQUIPMENT AND CHANNEL SCAN METHOD

(71) Applicant: FUJITSU CONNECTED TECHNOLOGIES LIMITED, Kawasaki-shi (JP)

(72) Inventor: Toshiya Tamura, Kokubunji (JP)

(73) Assignee: FUJITSU CONNECTED TECHNOLOGIES LIMITED, Kawasaki-shi (JP)

(21) Appl. No.: 16/117,831

(22) Filed: Aug. 30, 2018

(30) Foreign Application Priority Data
Sep. 26, 2017 (JP) 2017-184378

(51) Int. Cl. H04W 72/04; H04W 36/00

(52) U.S. Cl. CPC H04W 72/0446; H04W 72/0453; H04W 36/0061

(57) ABSTRACT

A mobile communication equipment includes a memory and a processor. The processor is coupled to the memory. The processor is configured to perform a first scanning a plurality of channels connectable to a wireless base station apparatus at a first interval, and a second scanning limited channels of the plurality of channels at a second interval shorter than average time of the first interval.

### CROSS-REFERENCE TO RELATED APPLICATION

This application is based upon and claims the benefit of priority of the prior Japanese Patent Application No. 2017-184378, filed on Sep. 26, 2017, the entire contents of which are incorporated herein by reference.

### FIELD

The embodiments discussed herein are related to a mobile communication equipment and a channel scan method.

### BACKGROUND

In a Wireless Local Area Network (wireless LAN, WLAN), wireless terminal is connected to a network via an access point by connecting to the access point. Alternatively, wireless terminals connected to the same access point perform communications with each other.

The wireless terminal, when connected to the access point, detects a beacon (Beacon) issued from the access point. The wireless terminals searches the communication-enabled access points by scanning usable channels at an interval, and tries to establish a connection to the access point transmitting the beacon exhibiting a high signal strength.

It is proposed that a technology of setting short a search interval when estimating that there is a high possibility of establishing the connection to an access point as a next connection target on the basis of information on the access point connected so far just before a disconnection. It is proposed that a technology of scanning only the channels used by the access points as connection candidates when executing a handover. It is proposed that a technology of searching only the channels used by the network as a connection target on the basis of the same access point information received when connected to the first access point.

### DOCUMENTS OF RELATED ARTS

### Patent Documents

[Patent Document 1] International Publication Pamphlet No. WO2009/078358

### [Patent Document 2] Japanese Laid-Open Patent Publication No. 2008-016991

### [Patent Document 3] Japanese Laid-Open Patent Publication No. 2011-004225

### SUMMARY

According to an aspect of the embodiments, a mobile communication equipment includes a memory and a processor. The processor is coupled to the memory. The processor is configured to perform a first scanning a plurality of channels connectable to a wireless base station apparatus at a first interval, and a second scanning limited channels of the plurality of channels at a second interval shorter than average time of the first interval.

The object and advantages of the invention will be realized and attained by means of the elements and combinations particularly pointed out in the claims. It is to be understood that both the foregoing general description and the following detailed description are exemplary and explanatory and are not restrictive of the invention.

### BRIEF DESCRIPTION OF DRAWINGS

FIG. 1 is a diagram illustrating one example of a configuration of a mobile communication equipment;

FIG. 2 is a chart illustrating a channel distribution of a 2.4 GHz band;

FIG. 3 is a chart depicting a channel distribution of a 5 GHz band;

FIG. 4 is a diagram illustrating one example of a channel scan;

FIG. 5 is a diagram illustrating one example of a power-save channel scan;

FIG. 6 is a diagram illustrating one example of a VoIP channel;

FIG. 7 is a diagram illustrating one example of a communication system;

FIG. 8 is a diagram illustrating one example of a hardware configuration of the mobile communication equipment;

FIG. 9 is a diagram illustrating one example of function blocks of the mobile communication equipment;

FIG. 10 is a diagram illustrating one example of scan channel information;

FIGS. 11A and 11B are diagrams illustrating one example of a channel scan mode;

FIG. 12 is a chart illustrating one example of a time chart of the channel scan in a power-save mode;

FIG. 13 is a flowchart illustrating an operation of an attribution monitoring process;

FIG. 14 is a flowchart illustrating an operation of a general connection establishing process; and

FIG. 15 is a flowchart illustrating an operation of a VoIP connection establishing process.

### DESCRIPTION OF EMBODIMENTS

Over the recent years, methods of utilizing the wireless LAN have been diversified; and the wireless LAN is utilized also for call services each providing a telephone function instanced by Voice over Internet Protocol (VoIP). A channel scan of the wireless LAN involves generally scanning all the connectable channels, resulting in an increase in power consumption. The power consumption is therefore restrained by performing a power-save channel scan contrived to extend the scan interval.

However, when returning again to a VoIP service area after exiting outside of this service area while using the VoIP attained by the wireless LAN, and when there is kept a status of the interval being extended due to the power-save channel scan, it follows that a considerable period of time is taken till establishing again the VoIP connection.

Embodiments will hereinafter be described with reference to the drawings.

### First Embodiment

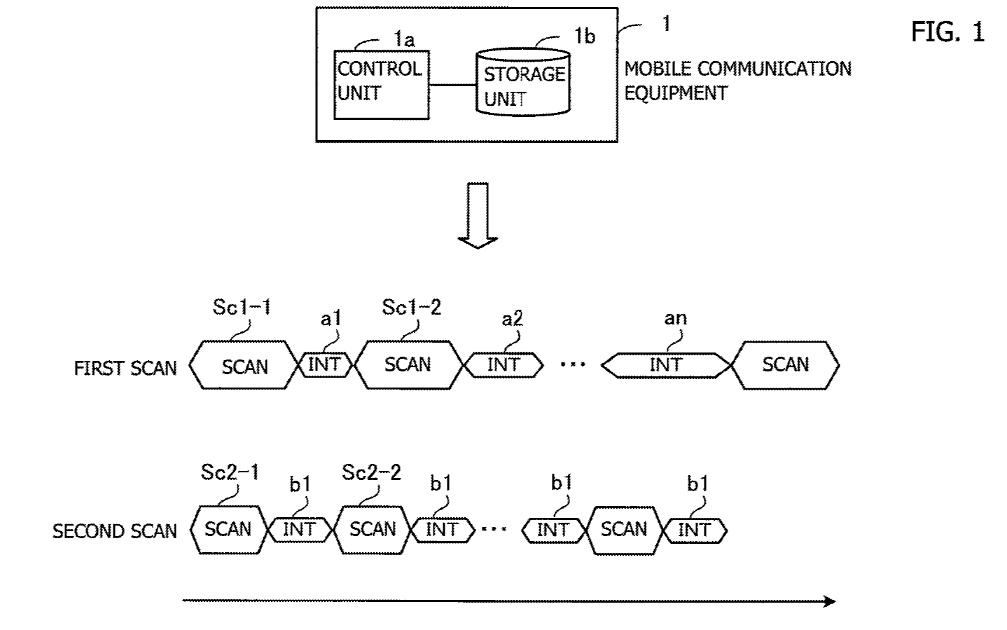

A mobile communication equipment of a first embodiment will be described with reference to FIG. 1. FIG. 1 is a diagram illustrating one example of a configuration of the mobile communication equipment. A mobile communication equipment 1 includes a control unit 1a and a storage unit 1b.

The control unit 1a performs a first scan of scanning a plurality of channels connectable to a wireless base station device (e.g., an access point) at a first interval, and a second scan of scanning a channel limited (limited channel) among the plurality of channels at a second interval shorter than average time of the first interval.

The storage unit 1b stores channel scan information related to the channels instanced by the limited channel to be scanned, and other control information. Note that a user may set an arbitrary channel as the limited channel.

An operation will be described with reference to an example illustrated in FIG. 1. The mobile communication equipment 1 is on the movement within an area, and searches the wireless base station device for establishing a connection with the self-equipment. In this case, channels via which the mobile communication equipment 1 is connectable to the wireless base station device are to be ch1, ch2, ch3 and ch4. The limited channels are to be ch1 and ch3 among these channels.

[First Scan]

The control unit 1a scans the channels ch1, . . . , ch4 connectable to the wireless base station device at intervals a1, a2, . . . , an (e.g., a1<a2< . . . <an).

The control unit 1a keeps scanning the channels while extending the interval till detecting the connectable wireless base station device. For example, when unable to detect the connectable wireless base station device at a scan Sc1-1, a scan Sc1-2 is conducted after the interval a2 longer than the interval a1. The same operation is hereinafter applied.

[Second Scan]

The control unit 1a scans the limited channels ch1 and ch3 among the channels ch1, . . . , ch4 connectable to the wireless base station device at an interval b1. The control unit 1a keeps scanning the channels at the interval b1 till detecting the connectable wireless base station device. For instance, when unable to detect the connectable wireless base station device at the scan Sc2-1, a scan Sc2-2 is carried out after the interval b1. The same operation is hereinafter applied.

As described above, the interval b1 of the second scan is set different from the intervals a1, a2, . . . , an of the first scan. Specifically, as described above, the average time of the interval b1 is set shorter than the average time of the intervals a1, a2, . . . , an.

Thus, the mobile communication equipment 1 scans the plurality of channels connectable to the wireless base station device at the first interval, and scans the limited channel in these channels at the second interval shorter than the average time of the first interval. The mobile communication equipment 1 is thereby enabled to reduce a period of time of connecting the wireless base station device oriented to the limited channel.

### Second Embodiment

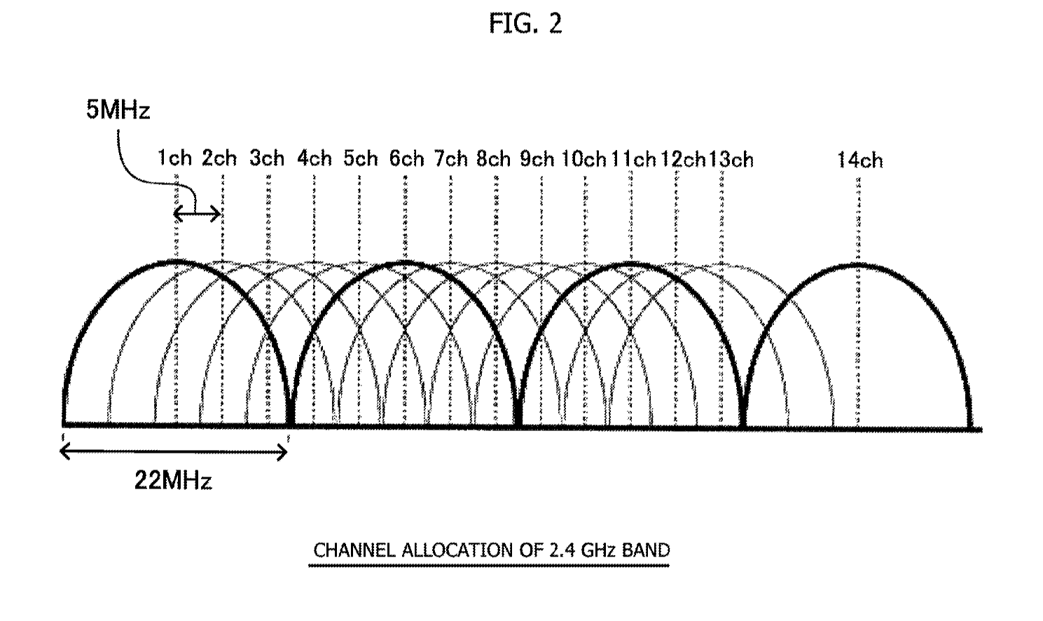

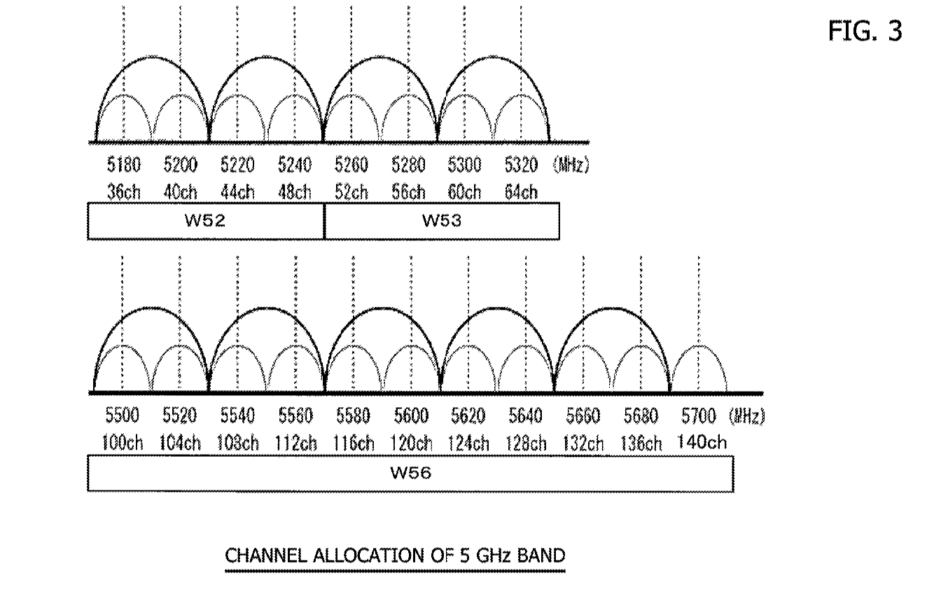

A second embodiment will next be described. The description will start with channel allocation of wireless LAN in a way that uses FIGS. 2 and 3. Normally, radio waves of a 2.4 GHz band and a 5 GHz band are used for the wireless LAN.

FIG. 2 is a chart illustrating a channel distribution of the 2.4 GHz band. The channels ch1-ch14 are allocated in the 2.4 GHz band according to IEEE (The Institute of Electrical and Electronics Engineers) 802.11b (the channels ch1-ch13 are allocated according to 802.11g).

The respective channels are spaced by every 5 MHz, and one channel width is 22 MHz, whereby communications via the wireless LAN may be performed at a designated channel. At the 2.4 GHz band, however, the neighboring channels have a possibility of causing radio interferences with each other, and hence it is domestically recommended that the channels are used by being spaced by 5 ch or larger such as ch1/ch6/ch11/ch14 so as not to cause the radio interferences. Note that central frequencies of the respective channels are set to 2.412 GHz for ch1, 2.437 GHz for ch6, 2.462 GHz for ch11 and 2.484 GHz for ch14.

FIG. 3 is a chart depicting a channel distribution of the 5 GHz band. IEEE802.11a involves using a frequency band, i.e., the 5 GHz band. The 5 GHz band does not cause any overlap between the channels and therefore enables 19 channels to be used simultaneously.

Note that the 5 GHz band is classified into three types W52, W53 and W56. The type W52 includes the channels ch36, ch40, ch44, ch48, and the type W53 includes the channels ch52, ch56, ch60, ch64.

The type W56 includes the channels ch100, ch104, ch108, ch112, ch116, ch120, ch124, ch128, ch132, ch136, ch140.

The types W52, W53 are inhibited from being used outdoors, while the type W56 is usable outdoors. The types W53, W56 implement functions of Dynamic Frequency Selection (DFC) and Transmit Power Control (TPC). The DFC is a function of changing the channel when detecting interference waves of a meteorological radar, and the TFC is a function of reducing a radio output for avoiding the interferences.

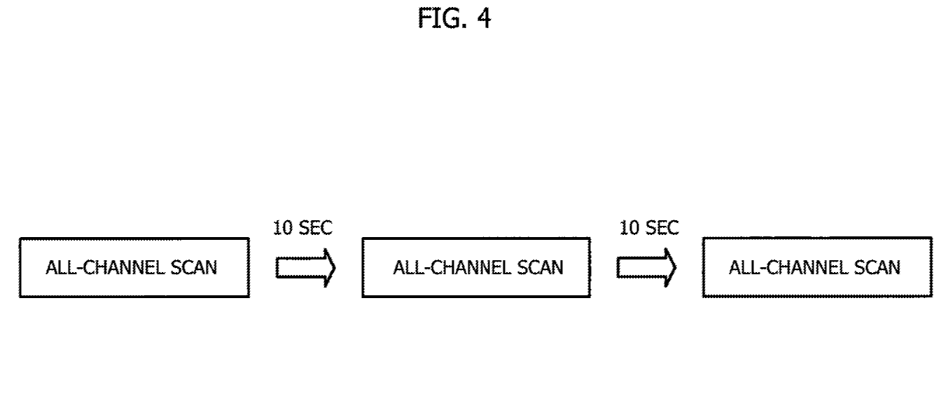

An operation of the channel scan and a technical issue arising when establishing the connection in a power-save channel scan status, will next be described with reference to FIGS. 4 through 6. FIG. 4 is a diagram illustrating one example of the channel scan. A wireless terminal performs scanning at a predetermined interval for checking whether a peripheral access point exists.

The wireless terminal sequentially scans the channels ch1, . . . , ch14 of the 2.4 GHz band and the channels included in the types W52, W53, W56 of the 5 GHz band at a normal operation time. When the scan of this series of channels is termed an “all-channel scan”, the all-channel scan is conducted at an interval of, e.g., 10 sec.

In the channel scan, the wireless terminal broadcasts a request, and waits a response from the access point (in the case of an active scan). Hence, when scanning all the channels as in FIG. 4, this results in an increase in power consumption. Consequently, the power consumption is restrained by extending the scan interval in such a scene that the user does not use the wireless LAN.

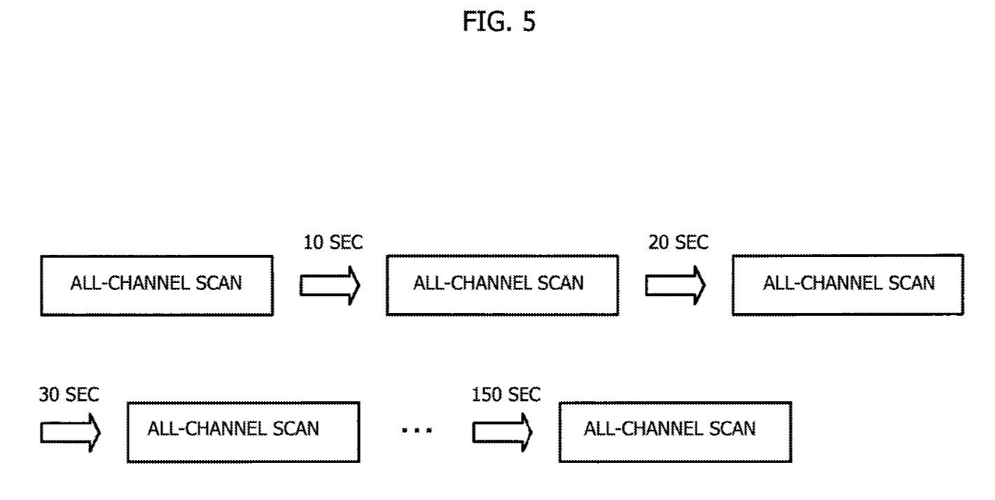

FIG. 5 is a diagram illustrating one example of the power-save channel scan. In the power-save channel scan for the purpose of saving electric power, the channels are scanned by extending the scan interval. In the example of FIG. 5, the interval for conducting the all-channel scan is increased by every 10 sec. Thus, the power consumption expended on the channel scan may be restrained by extending the interval for scanning the channels.

On the other hand, the wireless LAN is widely utilized for call services as by VoIP (Voice over Internet Protocol). The VoIP is such that the access points are installed at a fixed interval in a closed space instanced by an office, and a voice call is enabled to continue by seamlessly switching the access points through handovers even when the wireless terminal migrates. In a VoIP enabled area, the wireless terminal is set to receive an incoming call by establishing an ever-connection with the wireless LAN.

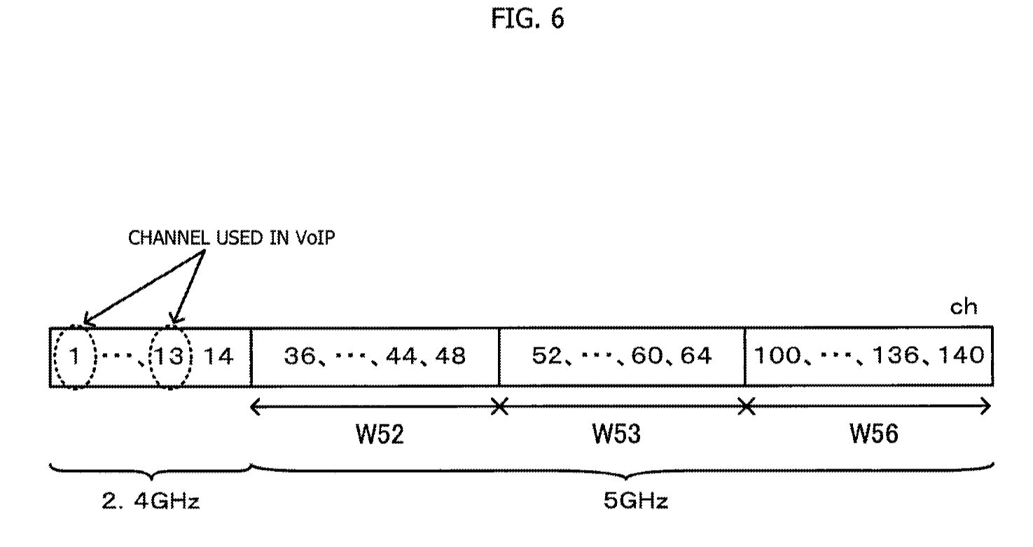

FIG. 6 is a diagram illustrating one example of VoIP channels. It is assumed that, e.g., the channels ch1 and ch13 of the 2.4 GHz band are allocated to VoIP. It is also assumed that the VoIP channels undergo the power-save channel scan in the VoIP enabled area.

In this status, when the wireless terminal migrates to another area from the VoIP enabled area and temporarily exits outside of a VoIP wireless LAN area (e.g., going outdoors, and other equivalent movements), the VoIP connection is disconnected, but is again established when the wireless terminal re-enters the VoIP wireless LAN area.

However, when set in the power-save channel scan status with the scan interval being extended as depicted in FIG. 5, a considerable period of time is taken till establishing a reconnection to the VoIP channel based on the wireless LAN.

The present disclosure, which is devised in view of these points, provides a mobile communication equipment, a channel scan method and a program each contrived to reduce connection time (or reconnection time) of a wireless LAN.

<System>

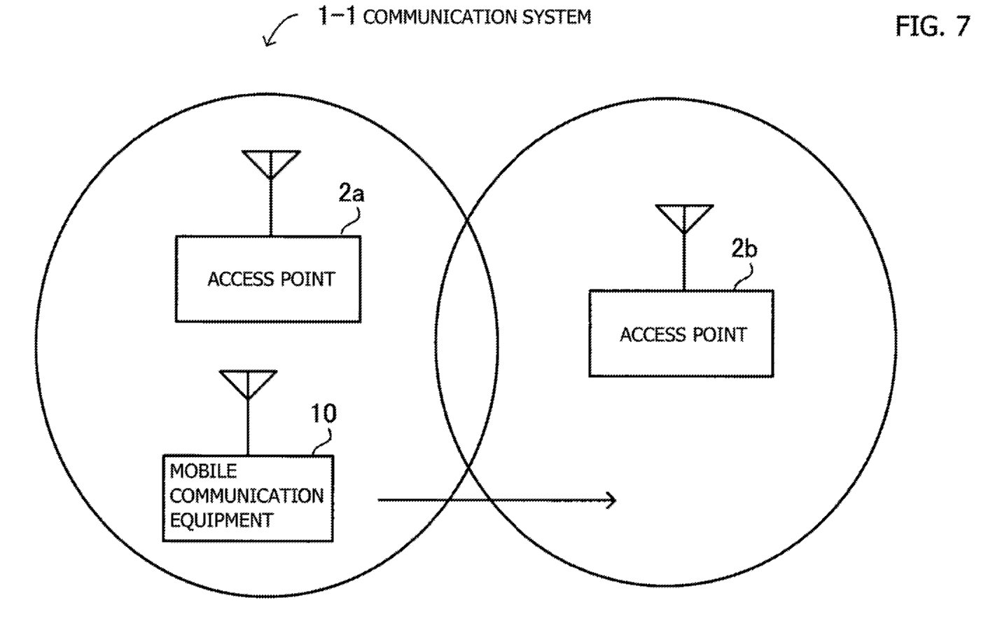

An in-depth description of a technology of the second embodiment will hereinafter be made. FIG. 7 is a diagram illustrating one example of a communication system. A communication system 1-1 includes a mobile communication equipment 10 having a function of the wireless terminal, and access points 2a, 2b each serving as a wireless base station apparatus. The communication system 1-1 performs the handover when the mobile communication equipment 10 migrates to a wireless area of the access point 2b from the wireless area of the access point 2a.

The mobile communication equipment 10 scans the channel when detecting the access points 2a, 2b. The channel scan is categorized into an active scan and a passive scan, which will hereinafter be briefly described.

In the active scan, the mobile communication equipment 10 broadcasts a probe request, and the access point receiving the probe request transmits a probe response to the mobile communication equipment 10.

The mobile communication equipment 10 detects an Service Set Identifier (SSID) of the access point by receiving the probe response, and measures an Received Signal Strength Indication (RSSI) given when receiving the probe response.

The mobile communication equipment 10 waits a reply for only minimum response time since transmitting the probe request, and scans the next channel by changing a using channel when having no reply during the minimum response time.

While on the other hand, when receiving some sort of reply during the minimum response time, the mobile communication equipment 10 scans the next channel by changing the using channel after waiting the reply for only maximum response time so as to make receivable a reply from another access point.

In the passive scan, the access point periodically transmits a beacon for informing the mobile communication equipment 10 of a self-existence. The mobile communication equipment 10 receives the beacon while sequentially switching the using channels, then detects an address of the access point and the using channel by receiving the beacon, and measures the RSSI given when receiving the beacon.

As described above, the channel scan is categorized into the active scan and the passive scan, and a channel scan technology of the present disclosure is, however, applicable to any type of channel scans. To be specific, the mobile communication equipment 10 actively scans the plurality of channels connectable to the access point at the first interval, and further actively scans the limited channel in these channels at the second interval shorter than the average time of the first interval.

Alternatively, the mobile communication equipment 10 passively scans the plurality of channels connectable to the access point at the first interval, and further passively scans the limited channel in these channels at the second interval shorter than the average time of the first interval.

<Hardware>

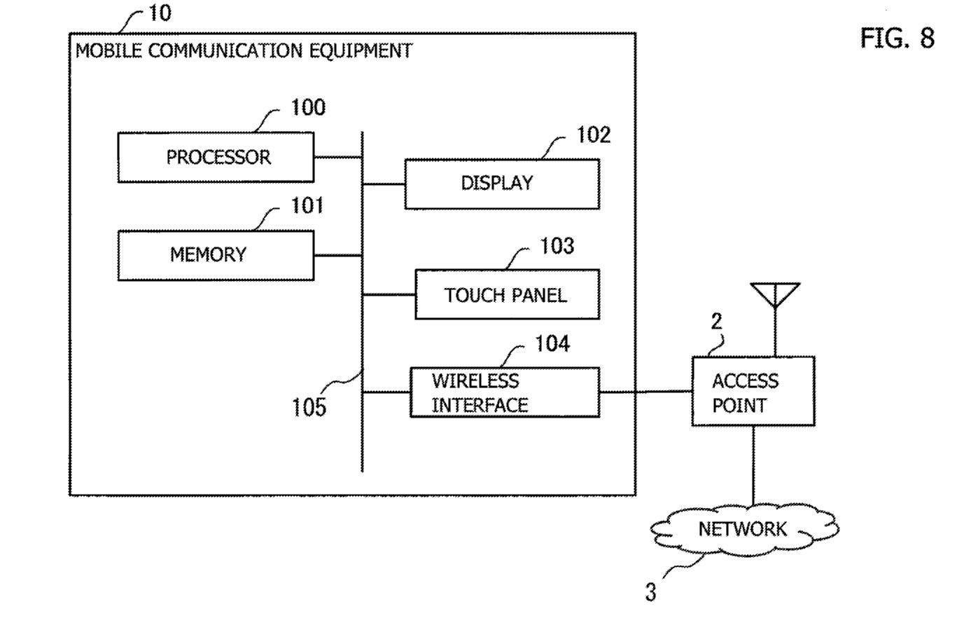

FIG. 8 is a diagram illustrating one example of a hardware configuration of the mobile communication equipment. The whole mobile communication equipment 10 is controlled by a processor 100. In other words, the processor 100 functions as a control unit of the mobile communication equipment 10.

A memory 101 and a plurality of peripheral devices are connected via a bus 105 to the processor 100. The processor 100 may be a multiprocessor. The processor 100 is instanced by a Central Processing Unit (CPU), a Micro Processing Unit (MPU), a Digital Signal Processor (DSP), an Application Specific Integrated Circuit (ASIC), or a Programmable Logic Device (PLD). The processor 100 may also be a combination of two or more elements among the CPU, the MPU, the DSP, the ASIC, and the PLD.

The memory 101 is used as a main storage device of the mobile communication equipment 10. The memory 101 has a storage function of a Random Access Memory (RAM) in which to temporarily store at least a part of a program of Operating System (OS) and application programs each run by the processor 100. Various items of data needed for processing by the processor 100 are stored in the memory 101.

The program of the OS, the application programs and the various items of data are stored in the memory 101 that is used also as an auxiliary storage device of the mobile communication equipment 10. The memory 101 may include, as an auxiliary storage device, a semiconductor storage device instanced by a flash memory and a Solid State Drive (SSD), or a magnetic recording medium instanced by an Hard Disk Drive (HDD).

A display 102, a touch panel 103 and a wireless interface 104 are given as the peripheral devices connected to the bus 105. The display 102 displays an image in accordance with an instruction given from the processor 100. The display 102 may be a Liquid Crystal Display (LCD), an organic Electro Luminescence (EL) display, and other equivalent displays.

The touch panel 103, which is provided in superposition on the display 102, detects a user's touch operation on the display 102, and notifies the processor 100 of a touch position as input signal.

A pointing device instanced by a touch pen, or a user's finger is used for the touch operation. There are a variety of detection methods as touch position detection methods instanced by a matrix switch method, a resistance film method, a surface acoustic wave method, an infrared-ray method, an electromagnetic induction method and an electrostatic capacity method; and any type of methods may be adopted. Note that the mobile communication equipment 10 may include other types of input devices such as a keypad equipped with a plurality of input keys.

The wireless interface 104 is a communication interface for performing the wireless communications. The wireless interface 104 demodulates/decodes a receiving signal, and encodes/modulates a transmitting signal, thus connecting a network 3 via the access point 2. The mobile communication equipment 10 may also include a plurality of wireless interfaces.

The hardware configuration described above enables a processing function of the mobile communication equipment 10 to be attained. The processor 100 runs respective predetermined programs, and the mobile communication equipment 10 is thereby enabled to perform the control of the present disclosure.

For example, the mobile communication equipment 10 runs a program recorded on a computer readable recording medium, thereby attaining the processing function of the present disclosure. The program describing a content of the processing to be run by the mobile communication equipment 10, may be recorded on a variety of recording mediums.

For instance, the program to be run by the mobile communication equipment 10 may also be stored in the auxiliary storage device. The processor 100 loads at least a part of the program within the auxiliary storage device onto the main storage device, and runs the program.

The program may also be recorded on a portable recording medium instanced by an optical disk, a memory device and a memory card. The program stored on the portable recording medium is enabled to run after being installed into the auxiliary storage device under, e.g., the control of the processor 100. The processor 100 reads the program directly from the portable recording medium, and may also run the program.

<Function Blocks>

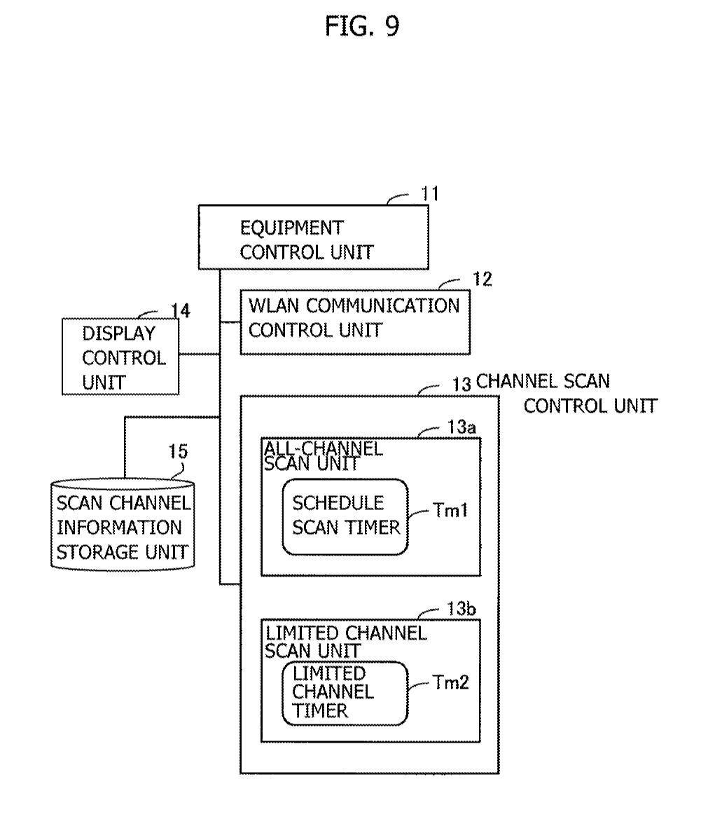

FIG. 9 is a diagram illustrating one example of function blocks of the mobile communication equipment. The mobile communication equipment 10 includes an equipment control unit 11, a WLAN communication control unit 12, a channel scan control unit 13, a display control unit 14, and a scan channel information storage unit 15.

The equipment control unit 11 controls, based on the software, the whole operation of the mobile communication equipment 10. The WLAN communication control unit 12 controls the communications of the wireless LAN based on IEEE802.11.

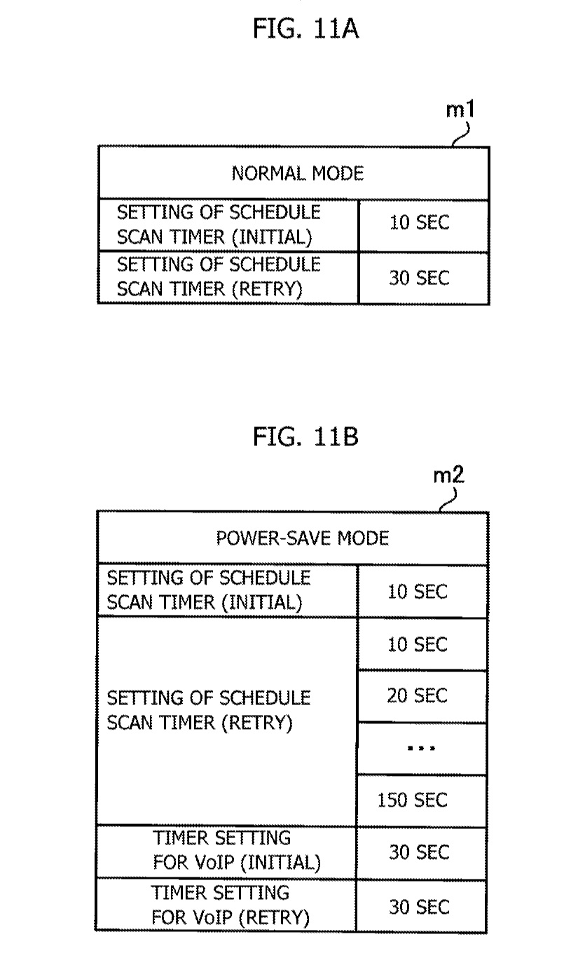

The channel scan control unit 13 scans the channels, based on a channel scan mode which will hereinafter be described in FIGS. 11A and 11B. The channel scan control unit 13 includes an all-channel scan unit 13a and a limited channel scan unit 13b, and executes the all-channel scan and the limited channel scan in parallel.

The all-channel scan unit 13a scans all the channels as scan target channels set by the self-equipment. For example, the all-channel scan unit 13a sequentially scans the channels ch1, . . . , ch14 of the 2.4 GHz band and the channels included in the types W52, W53, W56 of the 5 GHz band. The all-channel scan unit 13a has a schedule scan timer Tm1 (which will be described later in FIG. 11A) for setting the interval in the all-channel scan.

The limited channel scan unit 13b scans only the limited channels in all the channels as the scan target channels set by the self-equipment at the interval shorter than the interval for scan by the all-channel scan unit 13a.

It is assumed that, e.g., the channels ch1 and ch13 of the 2.4 GHz band are scanned as the limited channels. The limited channel scan unit 13b has a limited channel timer Tm2 (which will be described later in FIG. 11B) for setting the interval when scanning the limited channel.

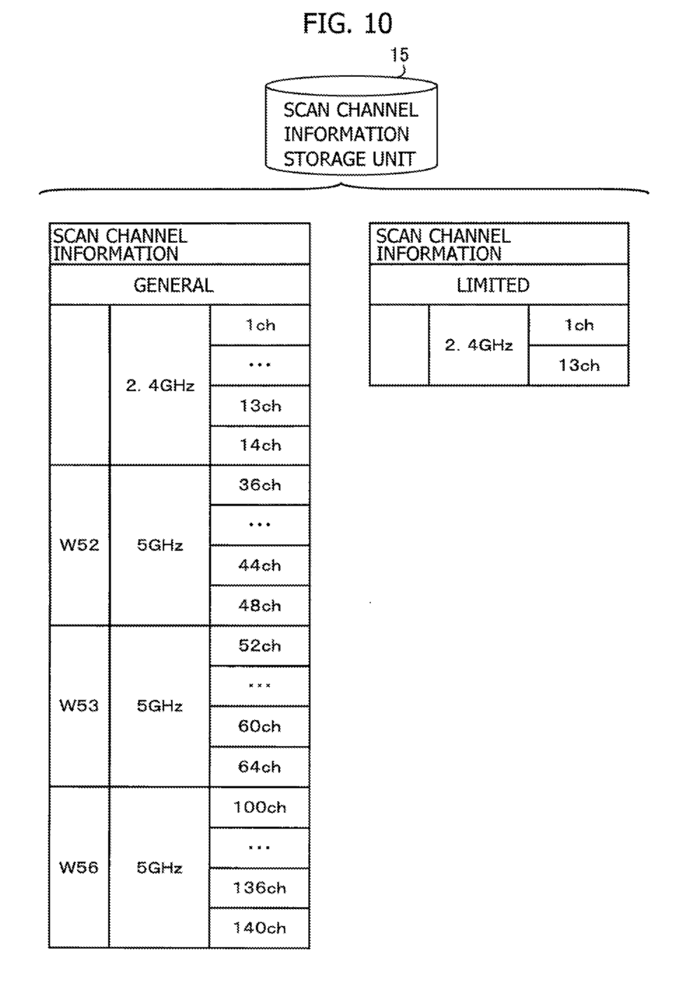

The display control unit 14 provides a Graphical User Interface (GUI) to the user, and thus display-outputs an operation input to the mobile communication equipment 10 and an operation status thereof. The scan channel information storage unit 15 stores scan channel information that will be described later in FIG. 10. The scan channel information is settable by the user.

Note that the equipment control unit 11, the WLAN communication control unit 12 and the channel scan control unit 13 are attained by the processor 100 depicted in FIG. 8. A display function of the display control unit 14 is attained by the display 102 illustrated in FIG. 8. The scan channel information storage unit 15 is attained by the memory 101 depicted in FIG. 8.

<Scan Channel Information>

FIG. 10 is a diagram illustrating one example of the scan channel information. The scan channel information stored in the scan channel information storage unit 15 is classified into scan channel information (general) and scan channel information (limited).

The scan channel information (general) is information about all the channels as the scan target channels, and is exemplified by the channels ch1, . . . , ch14 of the 2.4 GHz band and the channels included in the types W52, W53, W56 of the 5 GHz band, which are described above in FIGS. 2 and 3.

The scan channel information (limited) is information about the limited channels, and is exemplified by the channels ch1, ch13 of the 2.4 GHz band as the VoIP using channels. Note that the VoIP using channels are set not to overlap the mutual frequencies between the neighboring channels. Accordingly, other than the channels ch1 and ch13, such channels of the 2.4 GHz band as not to overlap their frequencies may also be set.

<Channel Scan Mode>

FIGS. 11A and 11B are diagrams illustrating one example of a channel scan mode. The channel scan mode has a normal mode m1 and a power-save mode m2. The normal mode m1 involves using the schedule scan timer and setting the interval for scanning the channels.

At an initial operation of the channel scan, the schedule scan timer is set to, e.g., 10 sec. The channel scan control unit 13 scans the channels at the interval of 10 sec.

The connection is not established through the channel scan at the interval of 10 sec, in which case the channel scan control unit 13 retries the channel scan. When retrying the channel scan, the schedule scan timer is set to, e.g., 30 sec for extending the interval. The channel scan control unit 13 scans the channels at the interval of 30 sec.

On the other hand, the power-save mode m2 involves using the schedule scan timer and the limited channel timer (VoIP timer), and setting the interval for the channel scan. At an initial operation of scanning all the channels, the schedule scan timer is set to, e.g., 10 sec. The channel scan control unit 13 scans the channels at the interval of 10 sec.

The connection is not established through the channel scan at the interval of 10 sec, in which case the channel scan control unit 13 retries the channel scan. The schedule scan timer is set to 10 sec at a first retry of the channel scan, and is set so as to extend the interval by every 10 sec from a second retry onward. Thus, the channel scan control unit 13 scans all the channels while extending the interval stepwise.

On the other hand, at the initial operation of scanning the VoIP channels (limited channels), the VoIP timer is set to, e.g., 30 sec. The channel scan control unit 13 scans the VoIP channels at the interval of 30 sec. When retrying the channel scan, the interval remains to be 30 sec.

<Channel Scan in Power-Save Mode>

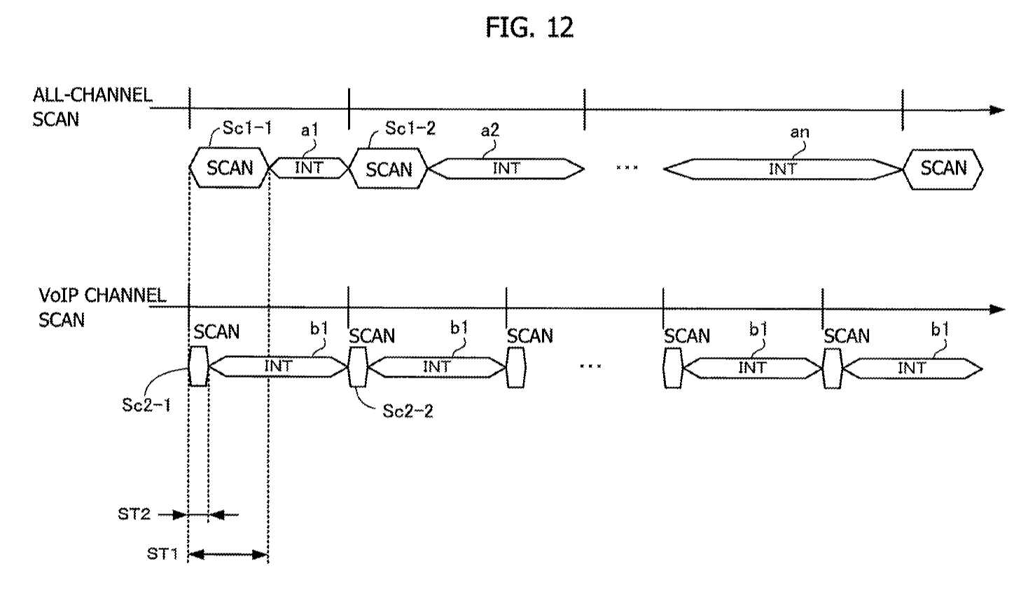

FIG. 12 is a chart illustrating one example of a time chart of the channel scan in the power-save mode.

[All-Channel Scan]

The channel scan control unit 13 scans the channels indicated by the scan channel information (general) at the intervals a1, a2, . . . , an (e.g., a1<a2<, . . . , <an). In a scan status ST1, there are scanned the channels ch1, . . . , ch14 of the 2.4 GHz band and the channels included in the types W52, W53, W56 of the 5 GHz band.

The channel scan control unit 13 scans the channels while extending the interval till detecting the connectable access point. For example, when unable to detect the connectable access point in the scan Sc1-2, the next scan of scan Sc1-2 is carried out after the interval a2 longer than the interval a1. The same operation is hereafter applied.

[VoIP Channel Scan]

The channel scan control unit 13 scans the VoIP channels indicated by the scan channel information (limited) at the interval b1. The channels ch1, ch13, defined as the VoIP channels, of the 2.4 GHz band are scanned in a scan status ST2.

The channel scan control unit 13 scans the channels at the interval b1 till detecting the connectable access point. For instance, when unable to detect the connectable access point in the scan Sc2-1, the scan Sc2-2 is carried out after the interval b1. The same operation is hereafter applied.

Herein, the average time of the interval b1 for scanning the VoIP channels is set shorter than the average time of the intervals a1, a2, . . . , an for scanning all the channels. In other words, the interval for scanning the VoIP channels is set shorter than the interval when performing the power-save channel scan.

The time taken for establishing the VoIP connection is thereby made reducible even when the mobile communication equipment 10 migrates from the VoIP enabled area to another area and again enters the VoIP wireless LAN area.

Note that as a number of channels set in the VoIP channels increases, a considerable period of time is taken till establishing the VoIP connection even when setting the interval at the VoIP channel scanning time shorter than the interval at the all-channel scanning time, resulting in a rise in power consumption.

The channel scan control unit 13 is therefore configured to scan the limited channels for only a predetermined period of time when a number of limited channels is set equal to or larger than a predetermined count. This contrivance enables the power consumption to be restrained because of a stop of scanning after scanning the VoIP channels for only the fixed time, when the VoIP channel count exceeds the predetermined count even in the VoIP channel scan.

<Flowchart>

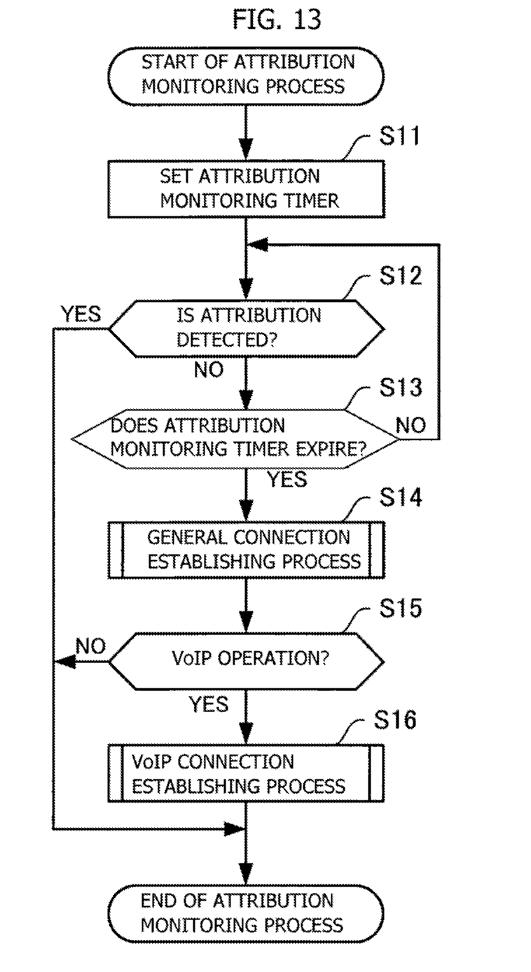

An operation of the mobile communication equipment 10 will hereinafter be described with reference to FIGS. 13 through 15. FIG. 13 is the flowchart indicating an operation of an attribution monitoring process. The attribution monitoring process is a process executed for monitoring whether the mobile communication equipment 10 is connected again to the access point having the same SSID, to which the mobile communication equipment 10 has been connected last time.

[Step S11] The channel scan control unit 13 sets an attribution monitoring timer.

[Step S12] The channel scan control unit 13 determines whether the self-equipment attributes thereto. The channel scan control unit 13 finishes the attribution monitoring process when detecting the attribution of the self-equipment (when connected again to the access point having the same SSID, to which the self-equipment has been connected before being disconnected).

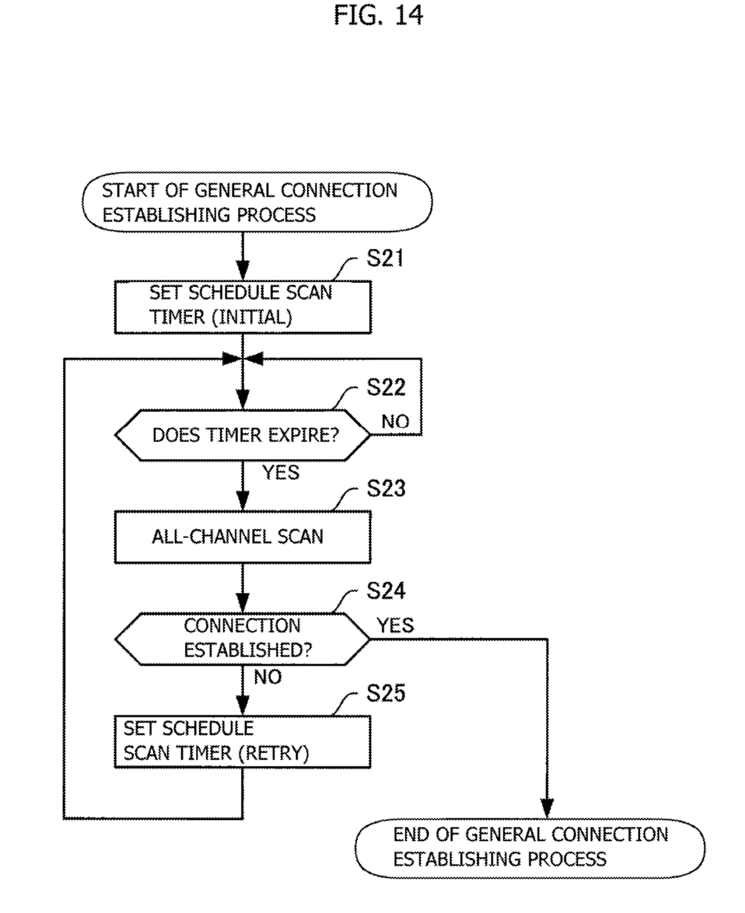

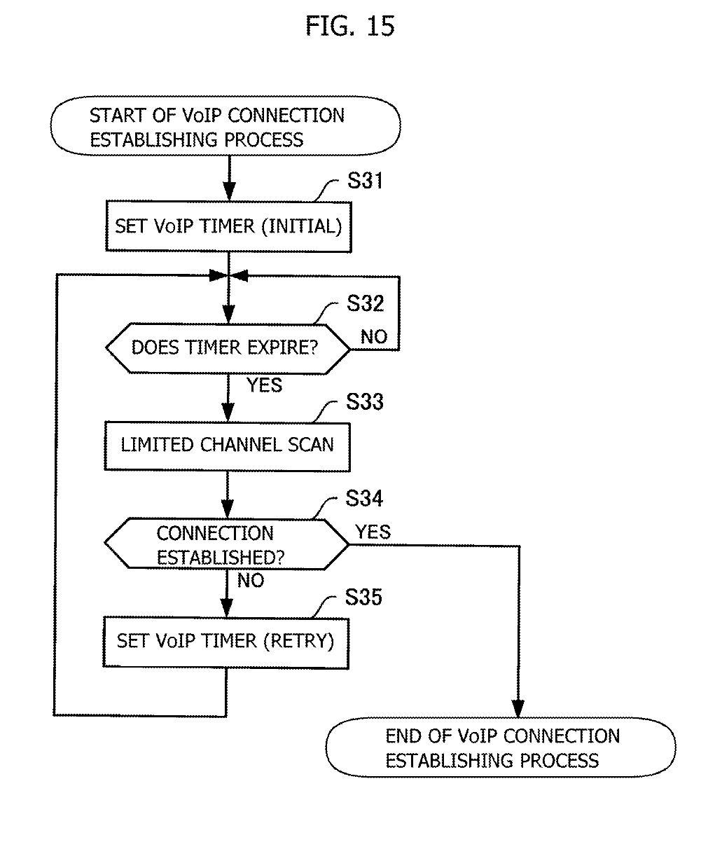

When the channel scan control unit 13 does not detect the attribution of the self-equipment (when not connected again to the access point having the same SSID, to which the self-equipment has been connected before being disconnected), the processing is proceeded to step S13.

[Step S13] The channel scan control unit 13 determines whether the attribution monitoring timer expires. The processing is proceeded to step S14 when the attribution monitoring timer expires but is looped back to step S12 whereas when the attribution monitoring timer does not expire.

[Step S14] The channel scan control unit 13 executes a general connection establishing process (which will hereinafter be described in FIG. 14).

[Step S15] The channel scan control unit 13 determines whether a VoIP operation is performed. The processing is proceeded to step S16 when performing the VoIP operation, but the attribution monitoring process is finished whereas when not performing the VoIP operation.

[Step S16] The channel scan control unit 13 executes a VoIP connection establishing process (which will hereinafter be described in FIG. 15). FIG. 14 is the flowchart indicating an operation of the general connection establishing process.

[Step S21] The channel scan control unit 13 sets the schedule scan timer on the occasion of scanning all the channels at the initial (first time) operation time.

[Step S22] The channel scan control unit 13 determines whether the schedule scan timer expires. The processing is proceeded to step S23 when the schedule scan timer expires, but the process in step S22 is repeated whereas when the timer does not yet expire.

[Step S23] The channel scan control unit 13 scans all the channels.

[Step S24] The channel scan control unit 13 determines whether the connection to the predetermined channel is established after scanning all the channels. The processing is proceeded to step S25 when the connection is not yet established, but the general connection establishing process is finished whereas when the connection is established.

[Step S25] The channel scan control unit 13 sets the schedule scan timer on the occasion of retrying the all-channel scan. The processing is looped back to step S22. FIG. 15 is the flowchart indicating an operation of the VoIP connection establishing process.

[Step S31] The channel scan control unit 13 sets the VoIP timer on the occasion of scanning the VoIP channels at the initial (first time) operation time.

[Step S32] The channel scan control unit 13 determines whether the VoIP timer expires. The processing is proceeded to step S33 when the VoIP timer expires, but the process in step S32 is iterated whereas when the VoIP timer does not expire.

[Step S33] The channel scan control unit 13 scans the limited channels limited to the use of the VoIP.

[Step S34] The channel scan control unit 13 determines whether the connection to the VoIP limited channel is established after scanning the VoIP channel. The processing is proceeded to step S35 when the connection is not yet established, but the VoIP connection establishing process is terminated when the connection is established.

[Step S35] The channel scan control unit 13 sets the VoIP timer on the occasion of retrying the scan of the VoIP limited channels. The processing is looped back to the process in step S32. The processing functions of the mobile communication equipments 1, 10 according to the present disclosure described so far may be attained by a computer. Provided in this case is a program that describes processing contents of the functions to be possessed by the mobile communication equipments 1, 10. The program is run by the computer, thereby attaining the processing functions on the computer.

The program describing the processing contents may be recorded on the computer readable recording medium. The computer readable recording medium is exemplified by a magnetic storage device, an optical disk, a magneto-optical recording medium and a semiconductor memory. The magnetic storage device is exemplified by a hard disk drive (HDD), a flexible disc (FD) and a magnetic tape. The optical disk is exemplified by a Digital Versatile Disc (DVD), a DVD Random Access Memory (DVD-RAM), and a Compact Disc Read Only Memory (CD-ROM)/Rewritable (RW). The magneto-optical recording medium is exemplified by a Magneto Optical disk (MO).

Distribution of the program entails, e.g., selling a portable recording medium instanced by the DVD and the CD-ROM on which the program is recorded. The program may also be pre-stored in a storage device of a server computer and transferred to other computers from the server computer via a network.

The computer, which runs the program, stores the program recorded on the portable recording medium or the program transferred from the server computer in a self storage device. The computer reads the program from the self storage device, and executes processes according to the program. Note that the computer may read the program directly from the portable recording medium, and may also execute the processes pursuant to the program.

Each time the program is transferred from the server computer connected via the network, the computer may sequentially execute the processes according to the received program. At least a part of the processing functions may also be attained by an electronic circuit instanced by the DSP, the ASIC and the PLD.

The embodiments have been exemplified as above, and the configurations of the respective units illustrated in the embodiments may be replaced by others having the same functions. Other arbitrary components and steps may also be added. What combines two or more arbitrary configurations (features) in the embodiments described above may also be available.

According to one aspect, it is feasible to reduce connection time of a wireless LAN.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A mobile communication equipment comprising:
a memory; and
a processor coupled to the memory and the processor configured to perform:
a first scanning a plurality of channels connectable to a wireless base station apparatus at a first interval, and
a second scanning limited channels of the plurality of channels at a second interval shorter than average time of the first interval.

2. The mobile communication equipment according to claim 1, wherein the processor extends the first interval stepwise, and fixes the second interval.

3. The mobile communication equipment according to claim 2, wherein the processor further executes:
setting a first period of time in the first interval at initial operation time of the first scanning, and to extend the first period of time each time when retrying the first scanning; and
setting the second interval of a fixed second period of time in the second scanning.

4. The mobile communication equipment according to claim 1, wherein the processor performs the second scanning for a predetermined period of time when there are a predetermined or more number of limited channels.

5. The mobile communication equipment according to claim 1, wherein the processor performs the first scanning and the second scanning in parallel.

6. The mobile communication equipment according to claim 1, wherein when plural limited channels exist, the limited channels not causing any overlap in mutual frequencies are set.

7. The mobile communication equipment according to claim 6, wherein the limited channel is a channel allocated to Voice over Internet Protocol (VoIP).

8. A channel scan method executed by a computer, the channel scan method comprising:
first scanning a plurality of channels connectable to a wireless base station apparatus at a first interval; and
storing limited channels of the plurality of channels in a memory and
second scanning the limited channels at a second interval shorter than average time of the first interval.

9. A non-transitory computer-readable recording medium storing a program that causes a computer to execute a process comprising:
first scanning a plurality of channels connectable to a wireless base station apparatus at a first interval; and
storing limited channels of these channels in a memory and
second scanning the limited channels at a second interval shorter than average time of the first interval.
